(19) United States
(12) Patent Application Publication
(10) Pub. No.: US 2024/0385468 A1
(43) Pub. Date: Nov. 21, 2024

(54) DYNAMICALLY RECONFIGURABLE OPTICAL METASURFACES

(71) Applicant: The Johns Hopkins University, Baltimore, MD (US)

(72) Inventors: David B. Shrekenhamer, Bethesda, MD (US); James B. Spicer, Columbia, MD (US); Andrew C. Strikwerda, Cambridge, MA (US); Adrian A. Podpirka, Washington, DC (US); Gabriella M. Hunt, Baltimore, MD (US); Joseph A. Miragliotta, Ellicott City, MD (US); Cameron A. Gutgsell, Laurel, MD (US)

(73) Assignee: The Johns Hopkins University, Baltimore, MD (US)

(21) Appl. No.: 18/661,172

(22) Filed: May 10, 2024

Related U.S. Application Data
(60) Provisional application No. 63/502,717, filed on May 17, 2023.

(51) Int. Cl. G02F 1/01

(52) U.S. Cl. CPC G02F 1/0147; G02F 2202/30; G02F 2203/18

(57) ABSTRACT

Disclosed herein are systems and methods of nano-engineered optical metasurfaces and materials able to generate higher efficiency flat optics and controlled surface emission via photothermally reconfigurable optical metasurfaces based on optical phase change materials (PCMs). Through localized control of the material dispersion, devices can operate at higher amplitudes and phase control for greater efficiency across larger operational bandwidth in the optical and infrared (IR) spectral regions.

### CROSS-REFERENCE TO RELATED APPLICATIONS

The present application claims priority to and filing benefit of U.S. Provisional Patent Application No. 63/502,717, filed on May 17, 2023, which is incorporated herein by reference in its entirety.

### BACKGROUND

Wireless communications, data transfer, computing, imaging, sensing, and energy management are a ubiquitous part of present day and future society. The ability to combine multiple optical elements into the design of wireless communication systems, data transfer systems, and/or energy management systems leading to better performance and reduced system bulk and complexity is necessary to maintain the growth within the communications and data transfer sector.

### SUMMARY

There exists a need for high-capacity, high-speed, safe, and efficient wireless data transfer systems, computing systems, imaging systems, and sensing systems as information dissemination continues to grow.

Some embodiments of the present disclosure utilize a dynamic optical metasurface comprising a substrate and a phase change material (PCM) film deposited on the substrate. The PCM film can be configured to be optically programmed to have a varying index of refraction in an infrared (IR) portion of an electromagnetic spectrum. In some embodiments, the PCM film can comprise an as-deposited amorphous state and/or an as-deposited crystalline state. In some embodiments, the PCM film can comprise a Group VA element and a Group VIA element (e.g., antimony (Sb) and sulfur(S)). In some embodiments, the PCM film can comprise a gradient-index (GRIN) optical film. In some embodiments, the PCM film can comprise an optically programmable chalcogenide film.

Some embodiments of the present disclosure utilize a method comprising depositing an amorphous phase change material (PCM) film onto a substrate, exposing the amorphous PCM film to laser radiation to convert at least a portion of the amorphous PCM film to a crystalline PCM film, heating the crystalline PCM film to revert the crystalline PCM film back to an amorphous PCM film, and optionally cycling the exposing and heating operations.

In some embodiments, the exposing, heating, and cycling comprise modulating a phase of a PCM film (e.g., modulating the phase of the PCM film comprises modulating a refractive index of a portion of the PCM film).

In some embodiments, the method further comprises templating the amorphous PCM film (e.g., the templating comprises forming a plurality of nanostructured pillars in the amorphous PCM film).

In some embodiments, the method further comprises annealing the plurality of nanostructured pillars in the amorphous PCM film after the templating.

In some embodiments, the forming the plurality of nanostructured pillars in the amorphous PCM film comprises forming a plurality of nanostructured pillars having long-range order.

Some embodiments of the present disclosure utilize a method comprising depositing a phase change material (PCM) film onto a substrate, where the PCM film can comprise a first phase, depositing a passivation layer on the PCM film, etching the passivation layer and the PCM film to provide a pattern, forming a plurality of nanopillars within the pattern, the plurality of nanopillars comprising a second phase within the PCM film dispersed across the substrate, and annealing the plurality of nanopillars, the passivation layer, and the PCM film, to provide a dynamic optical metasurface film comprising spatially varied PCM phases.

In some embodiments, the etching comprises conducting electron beam lithography and controlling nanopillar size by controlling beam current and target bias.

In some embodiments, the method further comprises forming a plurality of alumina (Al₂O₃) coated antimony sulfide (Sb₂S₃) pillars across the substrate having long-range order.

In some embodiments, the method further comprises forming a nanowaveguide structure, a photonic crystal structure, or a Mie resonant structure on the substrate, and tuning a resonance of the nanowaveguide structure, the photonic crystal structure, or the Mie resonant structure.

In some embodiments, the method further comprises forming spatially varied indices of refraction across the substrate.

Covered embodiments are defined by the claims, not this summary. This summary is a high-level overview of various aspects of the embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

### BRIEF DESCRIPTION OF THE DRAWINGS

The accompanying drawings are incorporated herein and form a part of the specification.

FIGS. 1A and 1B show a system and a magnified view of a portion of the system according to some embodiments of the present disclosure.

FIG. 2 shows a product according to some embodiments of the present disclosure.

FIG. 3 shows properties of an optical metasurface according to some embodiments of the present disclosure.

FIG. 4 shows properties of an optical metasurface according to some embodiments of the present disclosure.

FIG. 5 shows properties of an optical metasurface according to some embodiments of the present disclosure.

FIG. 6 shows an optical metasurface according to some embodiments of the present disclosure.

FIGS. 7A and 7B show an optical metasurface according to some embodiments of the present disclosure.

FIGS. 8A and 8B show an optical metasurface according to some embodiments of the present disclosure.

FIGS. 9A to 9C show optical metasurfaces and properties thereof according to some embodiments of the present disclosure.

FIGS. 10A to 10C show properties of an optical metasurface according to some embodiments of the present disclosure.

FIG. 11 shows properties of an optical metasurface according to some embodiments of the present disclosure.

FIGS. 12A to 12D show optical metasurfaces and properties thereof according to some embodiments of the present disclosure.

FIG. 13 is a flowchart showing a method according to some embodiments of the present disclosure.

FIG. 14 is a flowchart showing a method according to some embodiments of the present disclosure.

In the drawings, like reference numbers generally indicate identical or similar elements.

### DETAILED DESCRIPTION

As used herein, the meaning of “a,” “an,” and “the” includes singular and plural references unless the context clearly dictates otherwise.

All ranges disclosed herein are to be understood to encompass any and all endpoints as well as any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

The term “and/or” when used in a list of two or more items, means that any one of the listed items can be employed by itself or in combination with any one or more of the listed items. For example, the expression “A and/or B” is intended to mean either or both of A and B, i.e., A alone, B alone, or A and B in combination. The expression “A, B and/or C” is intended to mean A alone, B alone, C alone, A and B in combination, A and C in combination, B and C in combination or A, B, and C in combination.

Embodiments of the present disclosure can be directed to nano-engineered optical material and metasurfaces able to generate higher efficiency flat optics and controlled surface emission via photothermally reconfigurable optical metasurfaces based on optical phase change materials (PCMs). Through localized control of the material dispersion, devices can operate at higher amplitudes and phase control for greater efficiency across larger operational bandwidth in the optical and infrared (IR) spectral regions.

In some embodiments, dynamically reconfigurable optical metasurfaces present a pathway to achieving specific functionality in wireless data transfer systems (e.g., communications, the Internet of Things (IoT), aircraft intercommunications, outer space communications, autonomous vehicles, or the like).

In some embodiments, dynamically reconfigurable optical metasurfaces can provide optical elements that can be reversibly and repeatedly programmed depending on the demands of the application. In some aspects, PCMs such as chalcogenide glasses can be a functional material in the device structure. PCM phases can be switched between different solid states that can have significantly different optical properties (e.g., refractive index) across the electromagnetic (EM) spectrum, (e.g., the infrared (IR) spectrum and/or the visible spectrum). In some embodiments, various phase states can be patterned in an optical surface and can provide spatially varied optical properties. For example, phase change switching can be accomplished by optical, thermal, and/or opto-thermal processing.

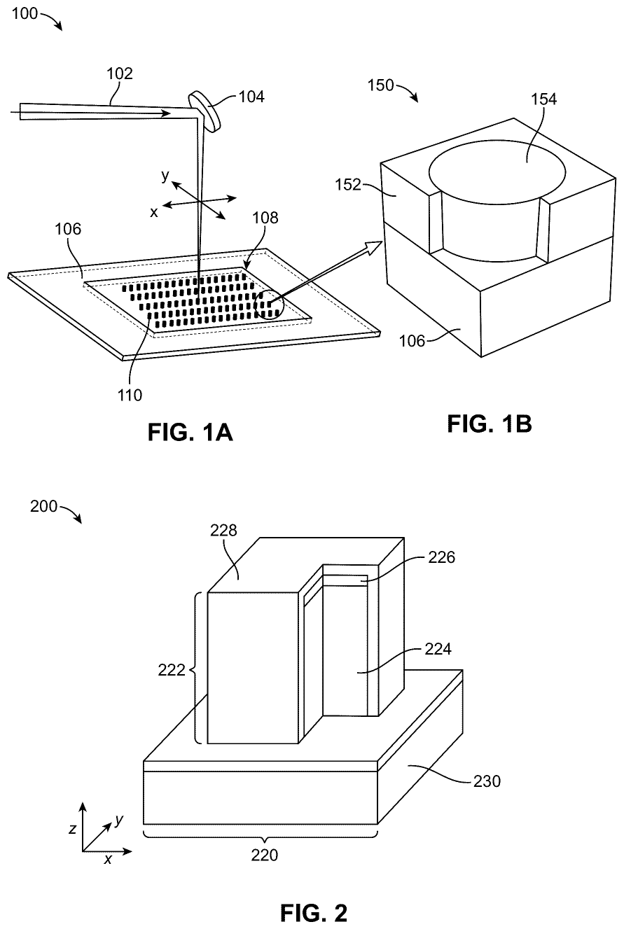

FIG. 1A shows a system 100 according to some embodiments of the present disclosure. For example, system 100 can be a schematic showing an electron-beam (E-beam) lithography set-up including an excitation beam 102, a raster mirror 104, and a substrate 106 including a phase-change material (PCM) film 108.

In some aspects, raster mirror 104 can be used to manipulate excitation beam 102 in an x-axis and/or a y-axis direction across substrate 106.

FIG. 1B shows a portion 150 of system 100 according to some embodiments. For example, portion 150 can be a magnified view of a single element 110 of PCM film 108. In some embodiments, element 110 can be a second phase PCM portion.

With reference to FIGS. 1A and 1B, in some aspects a first phase PCM film 152 (e.g., an amorphous PCM film) can be deposited on substrate 106 (e.g., fused silica, or any suitable substrate). In some aspects, excitation beam 102 can be used to excite a portion of first phase PCM film 152 to provide second phase PCM portion 154 (e.g., a crystalline PCM nanopillar).

In some aspects, PCM film 108 can be configured to be optically programmed to have a varying index of refraction in an infrared (IR) portion of the electromagnetic (EM) spectrum. In some embodiments, PCM film 108 can be deposited in an amorphous state and/or a crystalline state. In some aspects, PCM film 108 comprises a Group VA element and/or a Group VIA element (e.g., antimony (Sb) and sulfur(S)). In some embodiments, PCM film 108 can be a gradient-index (GRIN) optical film (e.g., having an index of refraction that varies across a length and/or a width of the PCM film). In some embodiments, PCM film 108 can an optically programmable chalcogenide film.

FIG. 2 shows a product 200 according some embodiments of the present disclosure. For example, product 200 can be a unit cell 220 including an alumina-coated nanopillar 222 that can include a center post 224, a hard mask 226, and a conformal coating 228 formed on a substrate 230.

In some aspects, center post 224 can include antimony sulfide (Sb₂S₃), antimony selenide (SbSe), germanium antimony telluride (Ge₂Sb₂Te₅ or GST), germanium antimony selenium telluride (Ge—Sb—Se—Te or GSST), germanium telluride (GeTe), or antimony telluride (SbTe).

In some aspects, hard mask 226 can be alumina (Al₂O₃), silicon nitride (SiNₓ), silicon oxide (SiOₓ), indium tin oxide (ITO), or any suitable hard mask material. In some aspects, hardmask 226 can be removed before further downstream processing.

In some aspects, conformal coating 228 can be Al₂O₃, SiNₓ, SiOₓ, any suitable low optical loss material, or the like.

In some aspects, unit cell 220 can have dimensions proportional to a wavelength of radiation manipulated by a plurality of unit cell 220 (e.g., IR radiation). For example, unit cell 220 can have lateral dimensions (e.g., along the x-axis and/or the y-axis) that can be smaller than λ₀/2, where λ₀ is a free space wavelength of the radiation (e.g., IR radiation). Unit cell 220 thickness (e.g., height along the z-axis) can be less than λ₀.

In some examples, e.g., a Mie resonant structure, unit cell 220 can have a period of about 480 nm in either or both the x-axis direction and the y-axis direction and coated nanopillar 222 can have a width ranging from about 280 nm to about 325 nm in either or both the x-axis direction and the y-axis direction.

In some aspects, a thickness (e.g., a z-axis height) of center post 224 is about 250 nanometers (nm), a thickness of hard mask 226 is about 20 nm, and a thickness of conformal coating 228 ranges from about 15 nm to about 50 nm (e.g., from about 15 nm to about 37.5 nm, from about 20 nm to about 40 nm, from about 15 nm to about 45 nm, or from about 16 nm to about 49 nm).

In some aspects, Al₂O₃ conformal coating 228 is conformally deposited on top of Sb₂S₃ center post 224, Al₂O₃ hard mask 226, and substrate 230 by atomic layer deposition (ALD), though any suitable thin film deposition operation can be used (e.g., sputtering, physical vapor deposition, chemical vapor deposition, or the like).

In some aspects, the ALD-deposited Al₂O₃ conformal coating 228 layer can be a passivation layer (e.g., a barrier) for crystallization (e.g., E-beam excitation) and/or a structure for maintaining a patterned geometry during an annealing operation and/or a melt-quenching operation, described below.

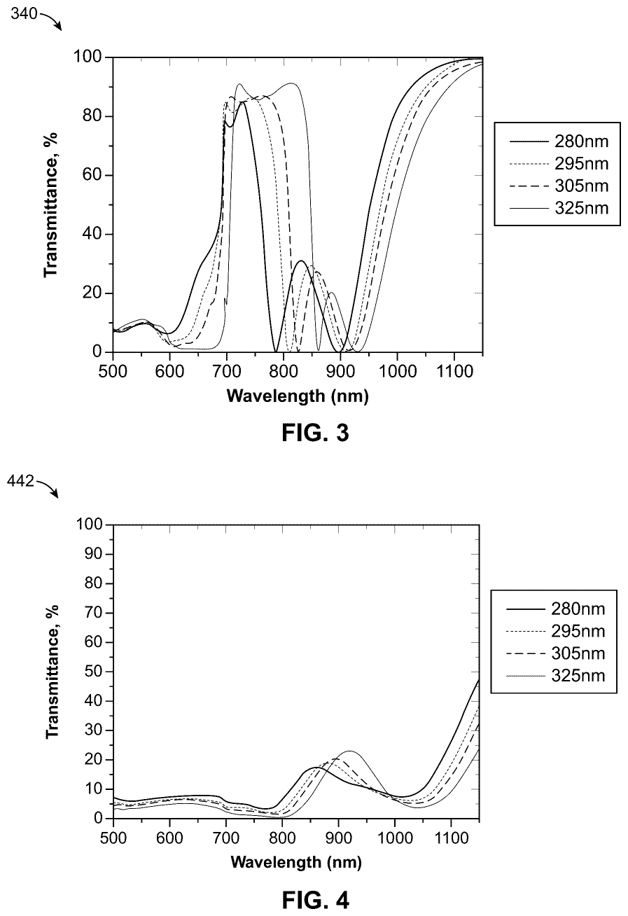

FIG. 3 and FIG. 4 show properties of an optical metasurface according to some embodiments of the present disclosure. For example, FIG. 3 can be a plot 340 showing Transmittance % along its y-axis and Wavelength in nm along its x-axis. In one aspect, plot 340 shows simulated transmittance data for an as-deposited amorphous Sb₂S₃ center post 224 (FIG. 2).

Also for example, FIG. 4 can be a plot 442 showing Transmittance % along its y-axis and Wavelength in nm along its x-axis. In one aspect, plot 442 shows simulated transmittance data for a crystallized Sb₂S₃ center post 224.

In some aspects, simulated transmittance data was acquired for various Sb₂S₃ center post 224 thicknesses. For example, simulated Sb₂S₃ center post 224 thicknesses included 280 nm, 295 nm, 305 nm and 325 nm as referenced in FIG. 3 and FIG. 4.

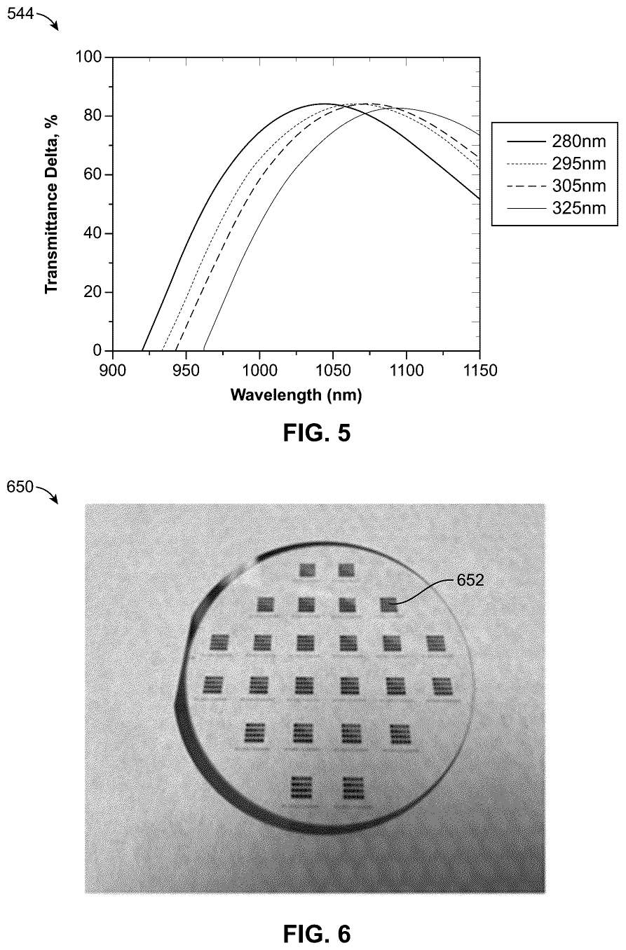

FIG. 5 shows properties of an optical metasurface according to some embodiments of the present disclosure. For example, FIG. 5 is a plot 544 showing Transmittance Delta % (e.g., a transmittance change) along its y-axis and Wavelength in nm along its x-axis. In one aspect, plot 544 shows a shift in transmitted wavelengths as a function of the metasurface post size (e.g., crystalline Sb₂S₃ center post 224, FIG. 2). In some aspects, varying crystalline Sb₂S₃ center post 224 size (e.g., from about 280 nm to about 325 nm) provided about an 80% reduction in absolute transmittance in the wavelength range of about 975 nm to about 1075 nm.

FIG. 6 shows an optical metasurface according to some embodiments of the present disclosure. For example, FIG. 6 is a digital image showing a wafer 650 having various metasurface geometries 652. Al₂O₃-coated nanopillars 222 (FIG. 2) can have various sizes by varying E-beam current and wafer 650 biasing parameters. In some aspects, Al₂O₃ hard mask 226 is critical to retain structure and prevent morphological changes (e.g., contraction due to density change) that can collapse Al₂O₃-coated nanopillars 222 during Al₂O₃ conformal coating 228 deposition. In other aspects, Al₂O₃ hard mask 226 is critical to prevent oxidation.

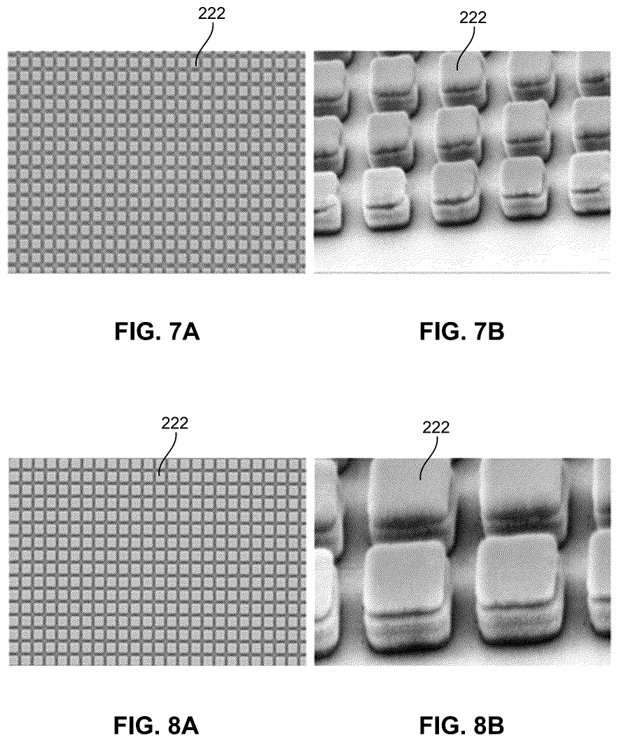

FIGS. 7A through 8B show an optical metasurface according to some embodiments of the present disclosure.

FIGS. 7A and 7B are scanning electron microscopy (SEM) images showing patterned amorphous (e.g., uncrystallized) Al₂O₃-coated nanopillars 222 (FIG. 2) according to some embodiments of the present disclosure.

FIGS. 8A and 8B are scanning electron microscopy (SEM) images showing patterned crystalline (e.g., E-beam excited) Al₂O₃-coated nanopillars 222 according to some embodiments of the present disclosure. In some aspects, the E-beam excitation did not alter the size and/or the shape of the Al₂O₃-coated nanopillars 222, thus, the Al₂O₃ hard mask 226 can preserve Al₂O₃-coated nanopillar 222 structural geometry.

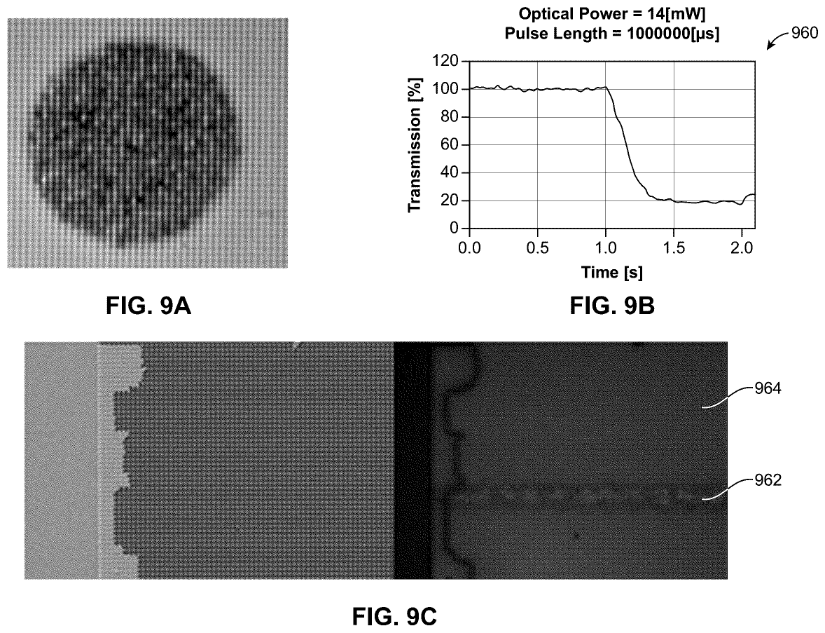

FIGS. 9A to 9C show optical metasurfaces and properties thereof according to some embodiments of the present disclosure. For example, a 405 nm laser can crystallize portions of an as-deposited first phase PCM film 152 (e.g., an amorphous PCM film). In some aspects, a 1064 nm laser can be used to observe a change in transmittance through the PCM film before and after crystallization.

In some aspects, FIG. 9A shows a crystallized region for a sample having 325 nm Sb₂S₃ posts (e.g., Sb₂S₃ center post 224, FIG. 2) according to some embodiments. In some aspects, the laser power can be 18 milliwatts (mW), a pulse width can be 1 second(s), a beam circumference can be 15 microns (μm), and the beam circumference can have a spot 50 μm out of focus.

FIG. 9B shows a plot 960 according to some embodiments. For example, plot 960 can show Transmission % on its y-axis and Time in seconds along its x-axis. In some embodiments, FIG. 9B shows a transmittance change as a function of time for a 1 s pulse of the 405 nm laser. As described above, probing can be performed using a 1064 nm laser.

In some aspects, it should be noted that the resulting transmittance is observed to be slightly higher than measured using FTIR due to a slight discrepancy in a co-linearity of the spot size. In some aspects, the sharp decline in transmittance after the 1 s pulse can demonstrate the programmability (e.g., the reconfigurability) of the PCM film.

FIG. 9C shows SEM and optical evaluation of a sample according to some embodiments. For example, the sample can have a line of second phase PCM portions 154 (e.g., a crystalline PCM nanopillar, FIG. 1) within first phase PCM film 152 (e.g., an amorphous PCM film, FIG. 1). In some aspects, FIG. 9C shows a crystallized line 962 within an amorphous PCM film 964. In some aspects, the right (optical) image shows optical contrast between first phase PCM film 152/964 (e.g., an amorphous PCM film) and second phase PCM portion 154 (e.g., crystallized line 962). In some aspects, the scanning electron image shows second phase PCM portions 154 (e.g., corresponding to crystallized line 962 in the optical (right) image) remain intact showing the ability to crystallize the optical metasurface without damaging the underlying structure or geometry.

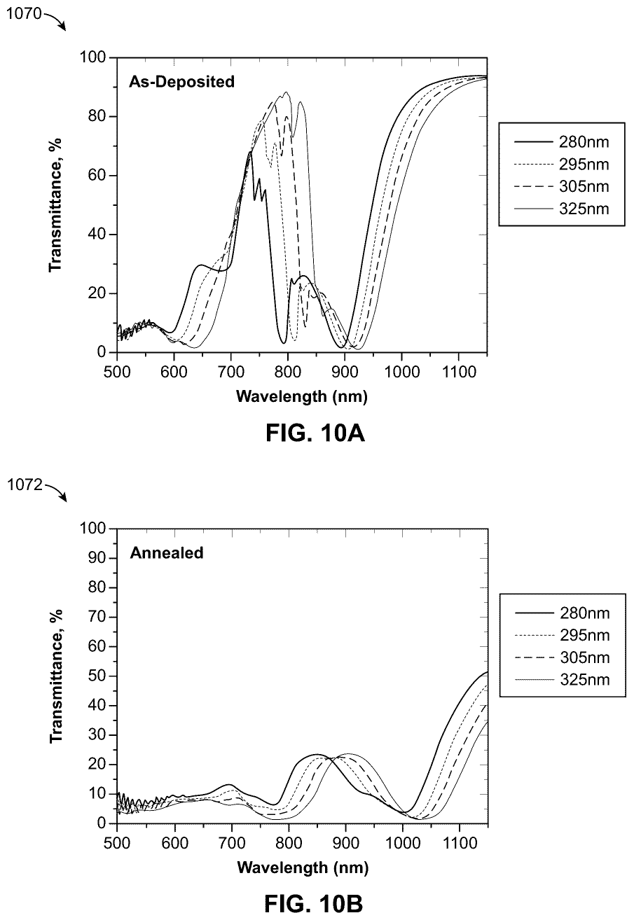

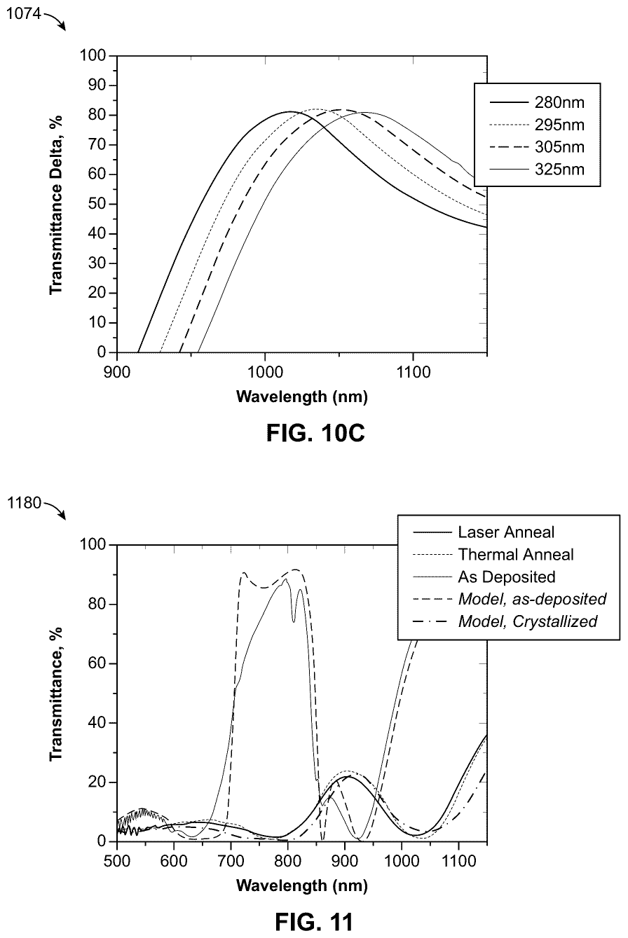

FIGS. 10A to 10C show plots 1070, 1072, and 1074 according to some embodiments. In one example, plots 1070 to 1074 show Transmittance % along their y-axis and Wavelength in nm along their x-axis. In some aspects, plots 1070 to 1072 can show properties of an optical metasurface according to some embodiments of the present disclosure. For example, FIGS. 10A and 10B show Fourier-Transform Infrared (FTIR) transmittance data of first phase PCM film 152 (e.g., an amorphous PCM film) and second phase PCM portions 154 (e.g., crystalline PCM nanopillars) according to some embodiments. In some aspects, FIG. 10C shows a contrast that is calculated as an absolute difference in the data contained in FIG. 10A and FIG. 10B. In some aspects, a maximum contrast is maintained with 80% transmittance contrast as a function of post dimension (e.g., crystalline Sb₂S₃ center post 224 dimension) spanning from 950 nm to 1050 nm in the plotted data.

In some aspects, and referring to the minimum transmittance in second phase PCM portion 154 (e.g., the crystalline PCM nanopillar) state (FIG. 10B), the contrast and minimum transmittance can be varied as a function of second phase PCM portion 154 (e.g., a crystalline PCM nanopillar, FIG. 1) dimensions.

In some aspects, larger second phase PCM portions 154 (e.g., crystalline PCM nanopillars) can provide a minimum transmittance and lower transmittance percent as the wavelength increases as shown in FIG. 10B.

Similarly, in some aspects first phase PCM film 152 (e.g., amorphous PCM film) samples, features of the transmittance curve can shift to longer wavelengths as the size of the pillar increases (FIG. 10A).

FIG. 11 shows a plot 1180 according to some embodiments. In some aspects, plot 1180 can show Transmittance % along a y-axis and Wavelength in nm along an x-axis. In some aspects, plot 1180 can show properties of an optical metasurface according to some embodiments of the present disclosure.

In some aspects, plot 1180 shows FTIR data comparing first phase PCM film 152 (e.g., an amorphous PCM film, FIG. 1, blue plot) with that of the second phase thermally annealed PCM film (e.g., heat crystallized, red plot) and a laser annealed PCM film (e.g., laser crystallized, black plot).

In some examples, laser annealing was performed using a 405 nm laser operated at a 1 s pulse width of 18 mW and a 15 μm beam circumference. In some aspects, thermal annealing was performed for 1 hour at 275° C. In the example of FIG. 11, dashed lines refer to modeled data.

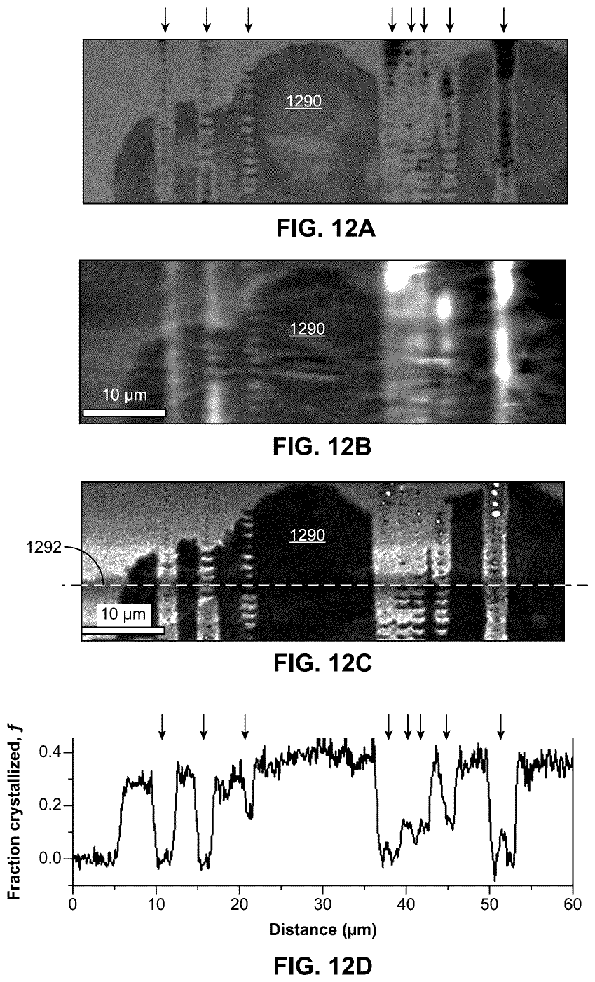

FIGS. 12A to 12D show optical metasurfaces and properties thereof according to some embodiments of the present disclosure. For example, FIGS. 12A to 12D show a contrast between first phase PCM film 152 (e.g., an amorphous PCM film, FIG. 1) and second phase PCM portion 154 (e.g., a crystalline PCM nanopillar, FIG. 1) as bright field microscopy analysis (FIG. 12A), topography analysis (FIG. 12B), and optical transmission analysis (FIG. 12C) compared to surface profile analysis (FIG. 12D).

In some aspects, FIG. 12A shows that bright field microscopy reveals regions 1290 crystallized using a 405 nm laser operating at 30 mW with a 250 ms pulse width and a 25 μm beam diameter.

In some aspects, FIG. 12A further shows narrower features (indicated by solid arrows in the example of FIGS. 12A-12D) corresponding to subsequent laser exposure operating at a power of 60 μW, a pulse width of 7.5 μs, and a 10 μm beam diameter.

In some aspects, the subsequent laser exposure provides a higher intensity and shorter pulse as compared to the crystallizing laser parameters that can re-amorphize the second phase PCM portion 154 (FIG. 1). In some aspects, changing first phase PCM film 152 (e.g., an amorphous PCM film) to second phase PCM portion 154 (e.g., a crystalline PCM nanopillar) can be a writing operation, and re-amorphizing the second phase PCM portion 154 (e.g., a crystalline PCM nanopillar) can be an erasing operation.

FIGS. 12B and 12C show topographical analysis and near-field scanning optical microscopy (NSOM) transmission analysis. In some aspects, and consistent with FIG. 12A, topographical depressions and reduced transmission correspond to second phase PCM portion 154 (e.g., a crystalline PCM nanopillar) region 1290. In some aspects, erase lines indicated by the solid arrows exhibit an optical transmission nearly identical to the first phase PCM film 152 (e.g., an amorphous PCM film, FIG. 1). In other words, the dynamically reconfigurable optical metasurface is nearly 100% reversible from phase to phase.

FIG. 12D shows profilometry data corresponding to the bright field microscopy analysis (FIG. 12A), topography analysis (FIG. 12B), and FTIR transmission analysis (FIG. 12C). In some aspects, the profile measurement was taken along the dashed line 1292 in FIG. 12C. In some aspects, write regions (e.g., second phase PCM portion 154 (e.g., a crystalline PCM nanopillar)) show crystallization fractions of about 40% and erase regions (e.g., re-amorphized PCM film regions indicated by solid arrows) show about 0% crystallization fractions. Thus, the materials and methods described herein can provide a dynamically reconfigurable optical metasurface.

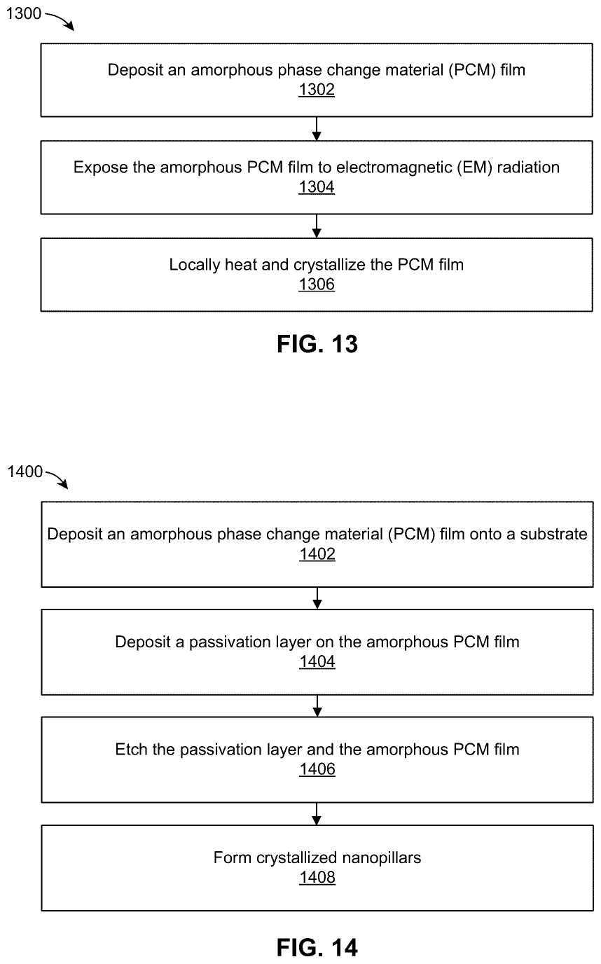

FIG. 13 is a flowchart showing a method 1300 according to some embodiments of the present disclosure. In some embodiments, method 1300 can provide a dynamically reconfigurable optical metasurface and includes depositing an amorphous phase change material (PCM) film onto a substrate, exposing the amorphous PCM film to laser radiation to convert at least a portion of the amorphous PCM film to a crystalline PCM film, locally heating the crystalline PCM film to revert the crystalline PCM film back to an amorphous PCM film, and optionally cycling the exposing and heating operations (e.g., write and erase operations). It is to be appreciated that not all operations need be performed or performed in the order shown. In one example, the operations shown relate to FIG. 1.

In some aspects, operation 1302 can deposit first phase PCM film 152 (e.g., an amorphous PCM film, FIG. 1) onto substrate 106 (e.g., a fused silica substrate, or any suitable substrate). In some aspects, depositing can be performed by any suitable deposition method, including spin-casting, dip-coating, chemical vapor deposition, physical vapor deposition, sputtering, atomic layer deposition, or the like.

In some aspects, operation 1304 can expose the deposited PCM film (e.g., first phase PCM film 152 (e.g., an amorphous PCM film)) to an electromagnetic radiation source to change the phase of the PCM film (e.g., from an amorphous phase to a crystalline phase, or from a crystalline phase to an amorphous phase). For example, the radiation source can be a laser, a thermal source, an ultraviolet source, a microwave source, an infrared source (e.g., an opto-thermal radiation source, including near-IR or any suitable portion of the IR spectrum), or the like.

In some aspects, operation 1306 can locally heat and crystallize the PCM film (e.g., second phase PCM portion 154 (e.g., a crystalline PCM nanopillar)) to anneal, partially anneal, or melt-quench the crystallized PCM film. Heating can be performed using an oven, a vacuum oven, a hot plate, or any suitable heat source. For example, the heating can partially solidify the passivation layer, the PCM film, and the crystallized nanopillars to provide a metastable optical metasurface resistant to phase change. In some aspects, the heating can fully solidify the passivation layer, the PCM film, and the crystallized nanopillars to provide a stable optical metasurface resistant to phase change. In some aspects, annealed crystallized nanopillars (e.g., crystalline Sb₂S₃ center post 224) can remain stable until exposed to laser, E-beam, or thermal radiation to re-amorphize the crystalline nanopillars (e.g., crystalline Sb₂S₃ center post 224). For example, the heating can be a melt-quench operation that can return the crystallized PCM film to an amorphous state.

In some aspects, the exposing operation 1304, the local heating operation 1306, and the optional cycling operation can include modulating a phase of the PCM film (e.g., modulating the phase of the PCM film comprises modulating a refractive index of a portion of the PCM film). In some embodiments, the method further comprises templating the amorphous PCM film (e.g., the templating comprises forming a plurality of nanostructured pillars in the amorphous PCM film in a chosen pattern).

In one aspect, operations 1302, 1304, and 1306 can be performed in a series of any combination, concomitantly, in any order, or in repetition.

FIG. 14 is a flowchart showing a method 1400 according to some embodiments of the present disclosure. For example, FIG. 14 depicts method 1400 that can provide a dynamically reconfigurable optical metasurface and including depositing a phase change material (PCM) film onto a substrate, wherein the PCM film comprises a first phase, depositing a passivation layer on the PCM film, etching the passivation layer and the PCM film to provide a pattern (e.g., templating), forming a plurality of nanopillars within the pattern, the plurality of nanopillars comprising a second phase within the PCM film dispersed across the substrate, and optionally annealing the plurality of nanopillars, passivation layer, and the PCM film, to provide a dynamic optical metasurface film comprising spatially varied PCM phases. It is to be appreciated that not all operations need be performed or performed in the order shown. In one example, the operations shown relate to FIG. 1 and FIG. 2.

In some aspects, operation 1402 can deposit an amorphous PCM material film (e.g., first phase PCM film 152 (FIG. 1)) onto a suitable substrate (e.g., a fused silica substrate).

In some aspects, operation 1404 can deposit a passivation layer onto the amorphous PCM material film. In certain aspects, the passivation layer can be an Al₂O₃ film deposited by any suitable deposition method (e.g., ALD, chemical vapor deposition, physical vapor deposition, sputtering, or the like). In some aspects, the passivation layer can be Al₂O₃ hard mask 226 (FIG. 2).

In some aspects, operation 1406 can etch the passivation layer and the amorphous PCM film. For example, etching can be performed by reactive ion etching (RIE), wet etching, E-beam lithography, laser etching, or any suitable etching procedure. In some aspects, the etching can be performed to provide unit cell 220 (FIG. 2), including Sb₂S₃ center post 224 and Al₂O₃ hard mask 226.

In some aspects, operation 1408 can form crystallized nanopillars. For example, operation 1408 forms second phase PCM portions 154 (e.g., crystalline Sb₂S₃ center post 224) from first phase PCM film 152, FIG. 1 and FIG. 2). For example, forming crystalline Sb₂S₃ center post 224 can be performed by any of the methods described above, including E-beam excitation, laser excitation, or thermal excitation (FIG. 1, FIG. 11).

In some aspects, an optional operation can anneal the etched passivation layer, PCM film, and crystallized nanopillars to provide the dynamically reconfigurable optical metasurface. For example, the annealing can partially solidify the passivation layer, the PCM film, and the crystallized nanopillars to provide to provide a metastable optical metasurface resistant to phase change. In some aspects, the annealing can fully solidify the passivation layer, the PCM film, and the crystallized nanopillars to provide to provide a stable optical metasurface resistant to phase change. In some aspects, the annealed crystallized nanopillars (e.g., crystalline Sb₂S₃ center post 224) can remain stable until exposed to laser, E-beam, or thermal radiation to re-amorphize the crystalline nanopillars (e.g., crystalline Sb₂S₃ center post 224).

In some aspects, operations 1402, 1404, 1406, and 1408 provide spatially varied PCM phases. In some embodiments, the method can provide a plurality of alumina (Al₂O₃) coated antimony sulfide (Sb₂S₃) nanopillars across the substrate having long-range order. In some aspects, the plurality of Al₂O₃-coated Sb₂S₃ nanopillars can have a random array, a concentric ordered array, or any suitable pattern. For example, a concentric ordered array can provide a metalens having a total phase shift of greater than 360°. In some aspects, the method can provide a nanowaveguide structure, a photonic crystal structure, or a Mie resonant structure on the substrate. In some aspects, the method can include tuning a resonance of the nanowaveguide structure, the photonic crystal structure, or the Mie resonant structure (e.g., by controlling spacing between nanopillars, by controlling size of the nanopillars, by controlling the pattern of the nanopillars, or any combination thereof). In some embodiments, the method further comprises forming spatially varied indices of refraction across the substrate (e.g., a GRIN optical film).

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A dynamic optical metasurface, comprising:
a substrate; and
a phase change material (PCM) film deposited on the substrate, the PCM film being configured to be optically programmed to have a varying index of refraction in an infrared (IR) portion of an electromagnetic spectrum.

2. The dynamic optical metasurface of claim 1, wherein the PCM film comprises an as-deposited amorphous state.

3. The dynamic optical metasurface of claim 1, wherein the PCM film comprises an as-deposited crystalline state.

4. The dynamic optical metasurface of claim 1, wherein the PCM film comprises a Group VA element and a Group VIA element.

5. The dynamic optical metasurface of claim 1, wherein the PCM film comprises antimony (Sb) and sulfur(S).

6. The dynamic optical metasurface of claim 1, wherein the PCM film comprises a gradient-index (GRIN) optical film.

7. The dynamic optical metasurface of claim 1, wherein the PCM film comprises an optically programmable chalcogenide film.

8. A method, comprising:
depositing an amorphous phase change material (PCM) film onto a substrate;
exposing the amorphous PCM film to laser radiation to convert at least a portion of the amorphous PCM film to a crystalline PCM film;
heating the crystalline PCM film to revert the crystalline PCM film back to an amorphous PCM film; and
cycling the exposing and heating operations.

9. The method of claim 8, wherein the exposing, heating, and cycling comprise modulating a phase of a PCM film.

10. The method of claim 9, wherein modulating the phase of the PCM film comprises modulating a refractive index of a portion of the PCM film.

11. The method of claim 8, further comprising templating the amorphous PCM film.

12. The method of claim 11, wherein the templating comprises forming a plurality of nanostructured pillars in the amorphous PCM film.

13. The method of claim 12, further comprising annealing the plurality of nanostructured pillars in the amorphous PCM film after the templating.

14. The method of claim 12, wherein the forming the plurality of nanostructured pillars in the amorphous PCM film comprises forming a plurality of nanostructured pillars having long-range order.

15. A method, comprising:
depositing a phase change material (PCM) film onto a substrate, wherein the PCM film comprises a first phase;
depositing a passivation layer on the PCM film;
etching the passivation layer and the PCM film to provide a pattern; and
forming a plurality of nanopillars within the pattern, the plurality of nanopillars comprising a second phase within the PCM film dispersed across the substrate.

16. The method of claim 15, wherein the etching comprises conducting electron beam lithography and controlling nanopillar size by controlling beam current and target bias.

17. The method of claim 15, further comprising forming a plurality of alumina (Al₂O₃) coated antimony sulfide (Sb₂S₃) pillars across the substrate having long-range order.

18. The method of claim 15, further comprising forming a nanowaveguide structure, a photonic crystal structure, or a Mie resonant structure on the substrate.

19. The method of claim 18, further comprising tuning a resonance of the nanowaveguide structure, the photonic crystal structure, or the Mie resonant structure.

20. The method of claim 15, further comprising forming spatially varied indices of refraction across the substrate.
